(19) United States
(12) Patent Application Publication
(10) Pub. No.: US 2011/0198346 A1
(43) Pub. Date: Aug. 18, 2011

(54) FUNCTIONAL-CONTAINER FORMING METHOD, MOLDING DIE, AND FUNCTIONAL CONTAINER PRODUCED BY THOSE

(75) Inventors: Toshifumi Takemori, Ichihara-shi (JP); Yoshiaki Takaya, Ichihara-shi (JP); Tomoaki Shimada, Ichihara-shi (JP)

(73) Assignee: MARUZEN PETROCHEMICAL CO., LTD., Tokyo (JP)

(21) Appl. No.: 13/023,888

(22) Filed: Feb. 9, 2011

(30) Foreign Application Priority Data
Feb. 15, 2010 (JP) 2010-029674

(51) Int. Cl. B65D 6/28; B29C 31/08

(52) U.S. Cl. 220/4.01; 264/279; 425/110

(57) ABSTRACT

It is an object of the present invention to provide a functional-container forming method and a molding die which can produce a functional container at a low cost and a high throughput without using a bond, and, a functional container produced by utilizing those. A functional-container forming method for forming a casing part on a bottom-face member having a predetermined functional surface, the functional-container forming method comprising the steps of: forming a protection region that suppresses a deterioration of a function of the functional surface between the functional surface and a molding die; and performing a molding by filling a melted resin in a cavity formed between the molding die and the bottom-face member.

### BACKGROUND OF THE INVENTION

1. Field of the Invention

The present invention relates to a functional-container forming method and a molding die which is for forming a casing at a bottom-face member having a predetermined functional surface, and a functional container produced by utilizing those.

2. Description of the Related Art

Recently, a fine structure in a micro or nano order is formed on the surface of a resin, etc., and various functions, such as a function as a photonic crystal, a function as plasmon resonance, and a function of causing cells to be spheroids, are added to a film, a substrate, etc.

It is desirable in some cases to form such film and substrate into a container-like shape depending on its application. When a container is formed, conventionally, a resin film or a resin substrate is used as a bottom-face member, and a casing is attached thereto by means of a bond or the like in order to produce a container (see, for example, WO2007/097120). Moreover, there is known a technology of arranging a resin film or a resin substrate in an injection molding die, and of injecting a deformable material against the injection molding die at high pressure, thereby forming a casing (see, for example, JP2000-513819A).

However, bonding of the bottom-face member to the casing by a bond reduces a throughput, and increases a cost. Moreover, when a bond is used for production of a culture container (vessel), the constituents of the bond is dissolved, and a culture media is contaminated. Furthermore, according to the method of arranging the resin film or the resin substrate in the injection molding die and of forming a casing by injection molding, as the mold abuts a functional surface, the functional surface may be physically damaged, and may be heated and chemically deteriorated.

It is an object of the present invention to provide a functional-container forming method, and a molding die which can produce a functional container at a low cost and a high throughput while suppressing any damage and deterioration of a functional surface without using a bond, and, a functional container produced by utilizing those.

### SUMMARY OF THE INVENTION

In order to accomplish the above object, a functional-container forming method according to a first aspect of the present invention is for forming a casing part on a bottom-face member having a predetermined functional surface, and the functional-container forming method comprises the steps of: forming a protection region that suppresses a deterioration of a function of the functional surface between the functional surface and a molding die; and performing a molding by filling a melted resin in a cavity formed between the molding die and the bottom-face member.

In this case, it is preferable that a difference in a water contact angle between a material of the bottom-face member and a material of the casing part should be equal to or smaller than 11 degrees. Moreover, it is preferable that a difference in a glass transition temperature or a melting point between a material of the bottom-face member and a material of the casing part should be equal to or lower than 50° C. When a material which is difficult to mold as a singular material, the material of the casing part can contain equal to or larger than at least 40 wt % of material having a difference in the water contact angle from the material of the bottom-face member being equal to or smaller than 11 degrees and having a difference in the glass transition temperature or the melting point from the material of the bottom-face member being equal to or lower than 50° C. It is preferable that the molding die should be divided into a plurality of pieces, and each piece should be released at a different timing. It is preferable that a temperature of the melted resin should be adjusted to be equal to or lower than a temperature at which the function of the functional surface is not deteriorated. Furthermore, it is preferable that a temperature of the bottom-face member should be adjusted to be equal to or lower than a temperature at which the function of the functional surface is not deteriorated.

A molding die according to a second aspect of the present invention is for forming a casing part on a bottom-face member having a predetermined functional surface, and the molding die comprises: a molding part for molding the casing part on the bottom-face member; and a functional-surface protecting part for forming a protection region that suppresses a deterioration of the functional surface at the time of molding between the functional surface and the molding die.

In this case, it is preferable that the molding part should be divided into a plurality of pieces, and each piece should be independently movable. Moreover, it is preferable that the functional-surface protecting part should have a portion which faces the functional surface at the time of molding and which is formed as a hollow. It is preferable that the functional-surface protecting part should have a portion which is proximate to the bottom-face member and which is formed as a curved surface. Furthermore, it is preferable that the functional-surface protecting part should be formed of a material having a lower thermal conductivity than the thermal conductivity of the molding part.

A functional container according to a third aspect of the present invention comprises: a bottom-face member having a predetermined functional surface; and a casing part joined to the bottom-face member by insert molding.

In this case, it is preferable that the functional container should be formed through the functional-container forming method of the first aspect of the present invention.

According to the present invention, a casing can be formed on a bottom-face member by insert molding, resulting in a low cost and a high throughput. Moreover, because the functional container of the present invention does not use a bond, the functional container will not be contaminated.

### BRIEF DESCRIPTION OF THE DRAWINGS

FIG. 1 is a schematic cross-sectional view showing a functional container according to the present invention;

FIG. 2 is a schematic cross-sectional view showing a molding die according to the present invention;

FIG. 3 is a schematic cross-sectional view for explaining how to remove a die according to the present invention; and

FIG. 4 is an SEM photograph showing a joint part between a bottom-face member of the functional container of the present invention and a casing thereof.

### DETAILED DESCRIPTION OF THE PREFERRED EMBODIMENT

The present invention is a functional-container forming method of forming a casing part 3 on a bottom-face member 2 having a predetermined functional surface 21. A protection region 9 that suppresses any deterioration of the function of the functional surface 21 is formed between the functional surface 21 and a molding die 5, and a melted resin is filled in a cavity formed between the molding die 5 and the bottom-face member 2 in order to perform molding.

The bottom-face member 2 configures the bottom of a functional container 1, and is formed in a film-like or substrate-like shape. Moreover, the functional surface 21 of the bottom-face member 2 fulfills various functions, such as a function as a photonic crystal, a function as plasmon resonance, and a function of causing cells to be spheroids, and configures the bottom face of the functional container 1. The function of the functional surface 21 can be added by, for example, forming a fine structure through a fine processing technology like imprinting, or by hydrophilic or hydrophobic surface processing through chemical modification or the like. Needless to say, the function of the functional surface 21 is not limited to those explained above as long as the functional surface 21 has any function.

The material of the bottom-face member 2 is not limited to any particular one as long as the predetermined functional surface 21 can be formed and can be joined to the material of the casing part by thermal fusion bonding. For example, when the functional surface 21 is formed with a fine structure through imprinting (thermal imprinting, photo imprinting), a thermoplastic resin can be used, such as a cyclic olefin resin like cyclic olefin ring-opening polymer/hydrogen additive (COP) or a cyclic olefin copolymer (COC), an acrylic resin, polycarbonate, a vinyl-ether resin, a fluorine resin like perfluoroalkoxyalkane (PFA) or polytetrafluoroethylene (PTFE), polystyrene (PS), acrylonitrile/butadiene/styrene resin (ABS), a polyimide resin, and a polyester resin. Moreover, a resin can be used which is produced by a polymerization reaction (thermal curing or photo curing) of a polymerizable-group containing compound like epoxide containing compound or unsaturated-hydrocarbon-group containing compound of vinyl group/allyl group, such as (meth)acrylic acid ester compound, vinyl-ether compound, bisallylnadiimide compound. Moreover, it is possible to use a solo polymerizable-group containing compound for thermal polymerization, and a thermal reactive initiator can be added in order to improve the thermo curing property. Furthermore, a photo reactive initiator may be added and a polymerization reaction may be promoted by irradiation with light, and a fine structure may be thus formed. Appropriate examples of the thermal reactive radical initiator are organic peroxide, and azo compound, and appropriate examples of the photo reactive radical initiator are acetophenone derivative, benzophenone derivative, benzoin ether derivative, and xanthone derivative. Moreover, reactive monomer may be used in a solventless manner, or may be dissolved in a solvent and desolvated after application.

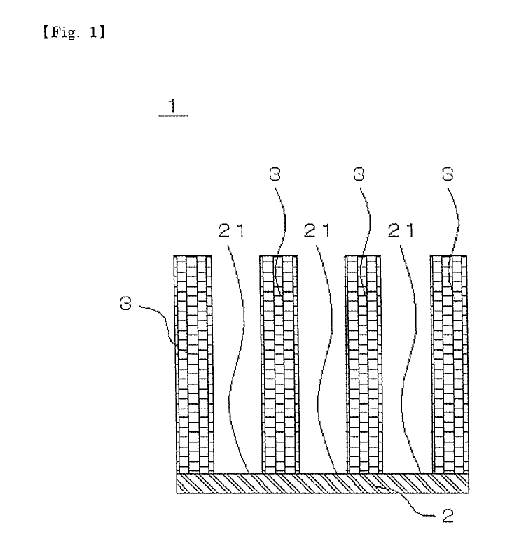

The casing part 3 configures the functional container 1 together with the bottom-face member 2, and as shown in FIG. 1, relative to the bottom-face member 2 that mainly configures the bottom of the container, the casing part 3 mainly configures a side of the container. For example, when the container is a multi-well, the casing part 3 includes plural cylinders configuring respective side faces of wells and a frame connecting those cylinders. Needless to say, the casing part 3 may be a petri dish, a dish, etc.

The material of the casing part 3 is not limited to any particular one as long as it can be used for injection molding and can be joined together with the bottom-face member 2 by insert molding, and for example, a thermoplastic resin can be used, such as a cyclic olefin resin like cyclic olefin ring-opening polymer/hydrogen additive (COP) or a cyclic olefin copolymer (COC), an acrylic resin, polycarbonate, a vinyl-ether resin, a fluorine resin like perfluoroalkoxyalkane (PFA) or polytetrafluoroethylene (PTFE), polystyrene (PS), acrylonitrile/butadiene/styrene resin (ABS), a polyimide resin, and a polyester resin. Moreover, the material of the casing part 3 may contain, depending on its purpose, an inorganic filler or reinforcing material, such as glass fiber, carbon black, or a talc, an organic or inorganic colorant, a stabilizer, an ultraviolet absorber, a dye compound, a lubricant, a flame retardant, and a neutron blocker.

Note that from the standpoint of joining, it is preferable that the difference in the water contact angle between the material of the bottom-face member 2 and that of the casing part 3 should be equal to or less than 11 degrees. The contact angle is one measured through the “droplet technique” in the “wettability test for a substrate glass surface” defined by JIS R 3257. For example, 3 μL of distilled water is dropped on a flat film or substrate formed of the material of the bottom-face member 2 or that of the casing part 3, the contact angle thereof is measured plural times using a contact angle measuring apparatus, and the average of the measured values is obtained.

If the difference of the glass transition temperature between the material of the bottom-face member 2 and that of the casing part 3 exceeds 50° C., at the time of insert molding, the bottom-face member 2 may be melted, the container may be distorted, which becomes a problem in the external appearance of the molded body. Moreover, the bottom-face member 2 and the casing part 3 are unable to be bonded together in some cases. Therefore, it is preferable that the difference in the glass transition temperature between the material of the bottom-face member 2 and that of the casing part 3 should be equal to or lower than 50° C. When the material of the casing part 3 contains an inorganic filler or reinforcing material, even if the temperature exceeds the glass transition temperature of the resin, softening and deformation by heating are suppressed, so that evaluation based on the difference in the glass transition temperature between individual materials becomes improper. In such a base, it is preferable that the difference in the melting point between individual materials should be equal to or lower than 50° C.

It is also possible to mix materials which are hardly bonded together because the difference in the contact angle exceeds 11 degrees or materials which are hardly bonded together because the difference in the glass transition temperature or the melting point exceeds 50° C. with the above-explained material proper for bonding. In this case, in order to obtain a sufficient bonding strength, it is preferable to mix the material of the casing part 3 with at least equal to or larger than 40 wt % of material having a water contact angle difference from the material of bottom-face member 2 equal to or larger than 11 degrees and having the glass transition temperature or melting point difference equal to or lower than 50° C.

Molding of the casing part 3 is performed by forming a protection region 9 that suppresses any deterioration of the function of the functional surface 21 between the functional surface 21 and the molding die 5. The protection region 9 prevents the die from abutting the functional surface 21 of the bottom-face member 2 by mold clamping at the time of insert molding, and thus suppressing any physical damage of the fine structure formed on the functional surface 21 and chemical deterioration of the functional surface 21 due to heat.

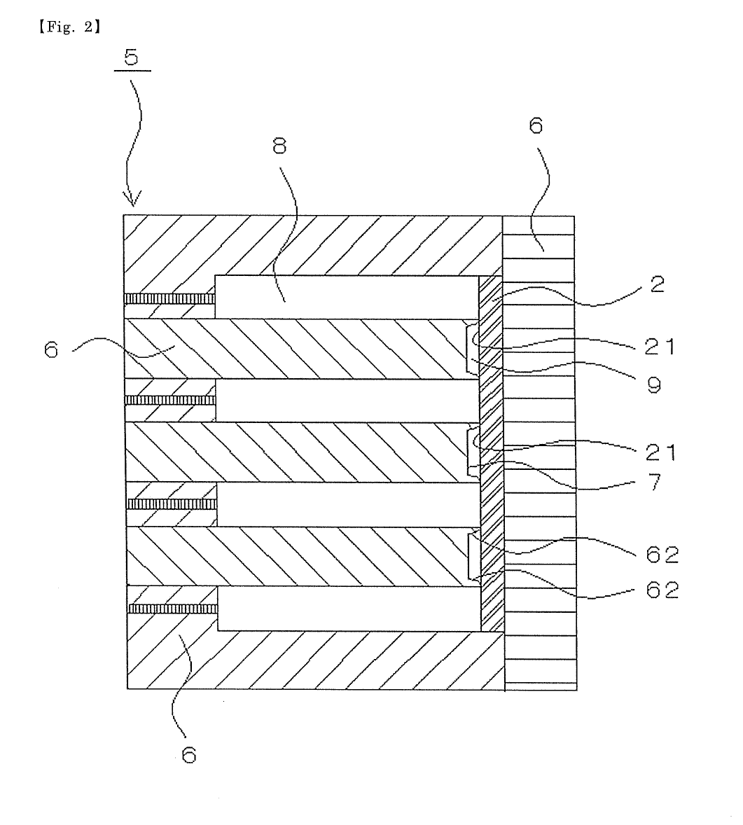

As shown in FIG. 2, the molding die 5 of the present invention includes molding parts 6 each for forming the casing part 3 on the bottom-face member 2 and functional-surface protecting parts 7 each for forming the above-explained protection region 9.

The molding part 6 is similar to the molds conventionally used for injection molding, and forms a cavity 8 where a melted resin is filled at the time of injection molding. The material of the molding part 6 is not limited to any particular one as long as it can be used for injection molding, and for example, is a metal like stainless steel. Note that cooling means may be provided for cooling the bottom-face member 2 in order to suppress any functional deterioration of the functional surface 21 due to heat at the time of molding. This enables temperature adjustment of the bottom-face member 2 so that the temperature thereof becomes equal to or lower than the temperature at which the function of the functional surface 21 is not deteriorated.

The functional-surface protecting part 7 forms a hollow at a portion where the molding part 6 faces the functional surface 21 at the time of molding. Accordingly, a space is formed between the die and the functional surface 21 as the protection region 9, thereby preventing the molding die 5 from abutting the functional surface 21 of the bottom-face member 2. Moreover, a gas present in such a space has a low thermal conductivity, and prevents the functional surface 21 from being heated. It is preferable that the functional-surface protecting part 7 should have a portion proximate to the bottom-face member 2 formed in a curved face 62 as shown in FIG. 2 in order to suppress any damage of the functional surface 21. Moreover, in order to protect the functional surface 21 against heat, the functional-surface protecting part 7 may be formed of a material having a lower thermal conductivity than that of the molding part 6. When the whole bottom-face member 2 has the functional surface 21 before the casing part 3 is molded, it is appropriate if the functional-surface protecting part 7 can protect only a portion which becomes the bottom of the functional container 1. Moreover, it is not necessary that the protection region 9 is in the form of a space (a gas), and as long as it is possible to suppress any deterioration of the function of the functional surface 21, the protection region 9 may be a soft material which hardly applies pressure against the functional surface 21 or a material having a low thermal conductivity.

After the molding die 5 is clamped, a melted resin is filled in the cavity 8 formed between the molding die 5 and the bottom-face member 2, thereby forming a casing. The melted resin is the melted material of the casing part 3, and the temperature thereof is adjusted so as to be equal to or lower than the temperature at which the function of the functional surface 21 is not deteriorated at the time of molding. The injection pressure of the melted resin is adjusted to pressure which can fill the melted resin into the cavity 8. When the resin is filled, in order to suppress any deterioration of the function of the functional surface 21, the bottom-face member 2 may be cooled down so as to be equal to or lower than a temperature at which the function of the functional surface 21 is not deteriorated.

Thereafter, the whole pieces are cooled down until the melted resin becomes hardened, and the molding die 5 is released from the molded body and the molded body is taken out, thereby completing the functional container 1 having the bottom-face member 2 and the casing part 3 formed together.

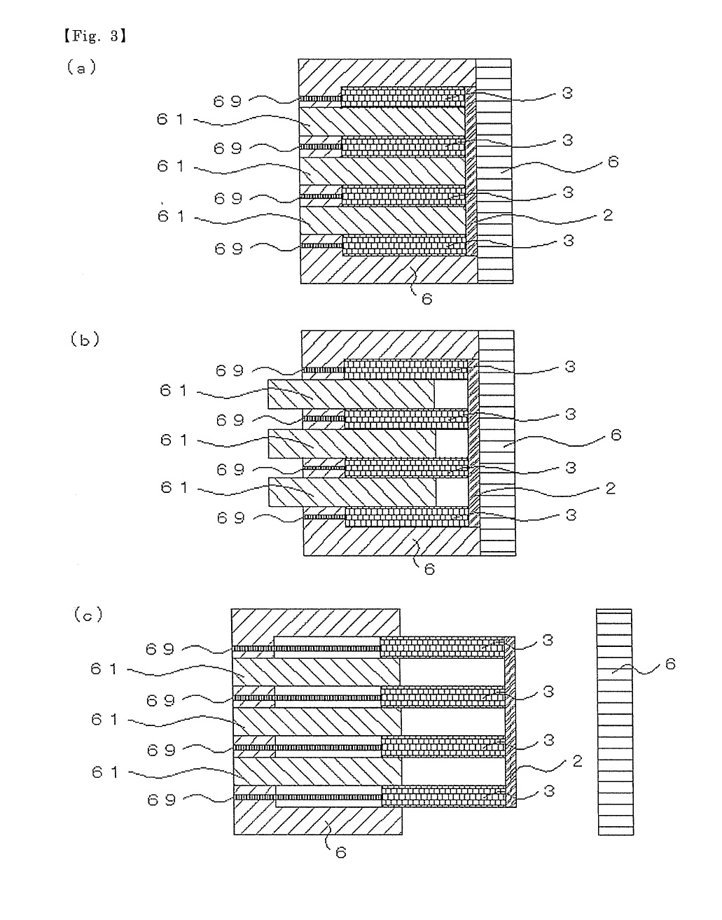

When the shape of the casing part 3 of the functional container 1 becomes complex and the surficial area thereof becomes large, it is difficult in some cases to release the die without a parting agent. However, if the parting agent is used, the functional container 1 is then contaminated by the parting agent. For example, in the cases of a biological device like a multi well plate used for cell culturing and an optical device used for a photo sensor, contamination by the parting agent must be avoided. Hence, in order to overcome this problem, it is appropriate if the molding part 6 of the molding die 5 is divided into plural pieces, and each piece is independently movable. For example, when a multi well is formed as the functional container 1, as shown in FIG. 3A, first, the resin is filled in the molding die, next, as shown in FIG. 3B, core pins 61 for configuring individual wells are released first, and as shown in FIG. 3C, the whole molded body is released from the die by protruding pins 69. Accordingly, the molding part 6 divided into plural pieces can be separately released at different timings, which facilitates a portion not easily released to be released from the die, thereby enabling formation of the functional container 1 without the parting agent.

### EXAMPLES

Next, an explanation will be given of examples of the method of forming a functional container using the molding die of the present invention and comparative examples.

Respective functional surfaces of the bottom-face members used in the examples and the comparative examples are formed with a fine structure having a line-and-space with a line width of 500 nm and a height of 250 nm (aspect ratio: approximately 0.5) and nano pillars each having a diameter of 210 nm and a height of 200 nm (aspect ratio: approximately 0.95).

The molding die used was made of stainless steel (SUS304) having cavities for forming a multi well plate (a functional container) with 96 holes. The molding die had core pins each for forming each well of the multi well plate at the movable die side, and the core pin had a hollow with a depth of approximately 500 μm as the functional-surface protecting part at the leading end thereof. The portion of the hollow closely contacting the bottom-face member was formed in a curved shape. Moreover, the bottom-face member was disposed on the fixed die side of the molding die.

Note that the contact angle was measured by dripping distilled water of 3 μL on a flat film or substrate formed of the material of the bottom-face member or the casing part, and by using the contact angle measuring device (AUTO SLIDING ANGLE SA-300DM) made by KYOWA interface science Co., Ltd., and the analyzing software (FACE measurement/analysis integrated system FAMAS version 2.1.0).

### First Example

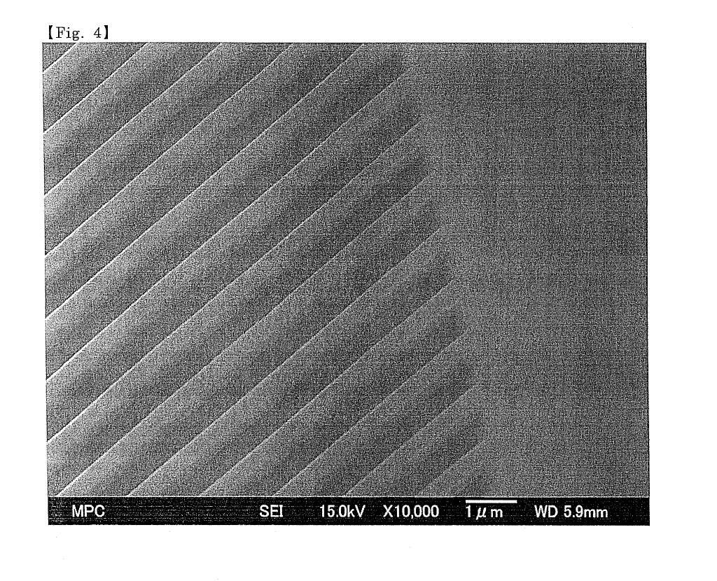

Insert molding was performed on a bottom-face member formed of cyclo-olefin polymer (ZF-14 made by ZEON Corporation, contact angle: 94.2 degrees, and glass transition temperature (Tg): 136° C.) using cyclo-olefin copolymer (COC) (TOPAS5013 made by Polyplastics Co., Ltd., contact angle: 83.7 degrees, and glass transition temperature (Tg): 134° C.) that was the material of a casing part. The temperature and the injection pressure of a melted resin were adjusted to 250° C., 135 MPa, respectively, and the temperature of the die was adjusted to 120° C. at the fixed side, and to 85° C. at the movable side. After the resin was injected, the die was cooled at a temperature equal to or lower than a temperature at which a molded body was hardened, and the molded body was released from the molding die and taken out therefrom. As a result, the bottom-face member and the casing part were firmly joined together. Moreover, the fine structure of the functional surface was maintained well, and there was no particular problem in appearance (see FIG. 4).

### Second Example

Insert molding was performed on a bottom-face member formed of cyclo-olefin polymer (ZF-14 made by ZEON Corporation, contact angle: 94.2 degrees, and glass transition temperature (Tg): 136° C.) using cyclo-olefin copolymer (COC) (TOPAS6013 made by Polyplastics Co., Ltd., contact angle: 83.5 degrees, and glass transition temperature (Tg): 138° C.) that was the material of a casing part. The temperature and the injection pressure of a melted resin were adjusted to 260° C., 150 MPa, respectively, and the temperature of the die was adjusted to 120° C. at the fixed side, and to 85° C. at the movable side. After the resin was injected, the die was cooled at a temperature equal to or lower than a temperature at which a molded body was hardened, and the molded body was released from the molding die and taken out therefrom. As a result, the bottom-face member and the casing part were firmly joined together. Moreover, the fine structure of the functional surface was maintained well, and there was no particular problem in appearance.

### Third Example

Insert molding was performed on a bottom-face member formed of cyclo-olefin polymer (ZF-14 made by ZEON Corporation, contact angle: 94.2 degrees, and glass transition temperature (Tg): 136° C.) using cyclo-olefin copolymer (COC) (1060R made by ZEON Corporation, contact angle: 84.9 degrees, and glass transition temperature (Tg): 100° C.) that was the material of a casing part. The temperature and the injection pressure of a melted resin were adjusted to 260° C., 130 MPa, respectively, and the temperature of the die was adjusted to 120° C. at the fixed side, and to 85° C. at the movable side. After the resin was injected, the die was cooled at a temperature equal to or lower than a temperature at which a molded body was hardened, and the molded body was released from the molding die and taken out therefrom. As a result, the bottom-face member and the casing part were firmly joined together. Moreover, the fine structure of the functional surface was maintained well, and there was no particular problem in appearance.

### Fourth Example

Insert molding was performed on a bottom-face member formed of cyclo-olefin polymer (ZF-14 made by ZEON Corporation, contact angle: 94.2 degrees, and glass transition temperature (Tg): 136° C.) using cyclo-olefin copolymer (COC) (480R made by ZEON Corporation, contact angle: 84.9 degrees, and glass transition temperature (Tg): 138° C.) that was the material of a casing part. The temperature and the injection pressure of a melted resin were adjusted to 275° C., 175 MPa, respectively, and the temperature of the die was adjusted to 120° C. at the fixed side, and to 85° C. at the movable side. After the resin was injected, the die was cooled at a temperature equal to or lower than a temperature at which a molded body was hardened, and the molded body was released from the molding die and taken out therefrom. As a result, the bottom-face member and the casing part were firmly joined together. Moreover, the fine structure of the functional surface was maintained well, and there was no particular problem in appearance.

### Fifth Example

Insert molding was performed on a bottom-face member formed of cyclo-olefin copolymer (COC) (TOPAS5013 made by Polyplastics Co., Ltd., contact angle: 84.1 degrees, and glass transition temperature (Tg): 134° C.) using PMMA (poly-methylmethacrylate) (Acrypet (registered trademark) (grade MD) made by MITSUBISHI RAYON Co., Ltd., contact angle: 73.2 degrees, and glass transition temperature (Tg): 105° C.) that was the material of a casing part. The temperature and the injection pressure of a melted resin were adjusted to 260° C., 175 MPa, respectively, and the temperature of the die was adjusted to 120° C. at the fixed side, and to 85° C. at the movable side. After the resin was injected, the die was cooled at a temperature equal to or lower than a temperature at which a molded body was hardened, and the molded body was released from the molding die and taken out therefrom. As a result, the bottom-face member and the casing part were firmly joined together. Moreover, the fine structure of the functional surface was maintained well, and there was no particular problem in appearance.

### Sixth Example

Insert molding was performed on a bottom-face member formed of cyclo-olefin copolymer (COC) (TOPAS6013 made by Polyplastics Co., Ltd., contact angle: 76.7 degrees, and glass transition temperature (Tg): 138° C.) using PMMA (poly-methylmethacrylate) (Acrypet (registered trademark) (grade MD) made by MITSUBISHI RAYON Co., Ltd., contact angle: 73.2 degrees, and glass transition temperature (Tg): 105° C.) that was the material of a casing part. The temperature and the injection pressure of a melted resin were adjusted to 260° C., 175 MPa, respectively, and the temperature of the die was adjusted to 120° C. at the fixed side, and to 85° C. at the movable side. After the resin was injected, the die was cooled at a temperature equal to or lower than a temperature at which a molded body was hardened, and the molded body was released from the molding die and taken out therefrom. As a result, the bottom-face member and the casing part were firmly joined together. Moreover, the fine structure of the functional surface was maintained well, and there was no particular problem in appearance.

### Seventh Example

Insert molding was performed on a bottom-face member formed of cyclo-olefin copolymer (COC) (TOPAS8007 made by Polyplastics Co., Ltd., contact angle: 86.0 degrees, and glass transition temperature (Tg): 78° C.) using polystyrene (PS) (Mw=192,000 pellet made by ALDRICH Co., Ltd., contact angle: 82.7 degrees, and glass transition temperature (Tg): 100° C.) that was the material of a casing part. The temperature and the injection pressure of a melted resin were adjusted to 240° C., 135 MPa, respectively, and the temperature of the die was adjusted to 85° C. at the fixed side, and to 85° C. at the movable side. After the resin was injected, the die was cooled at a temperature equal to or lower than a temperature at which a molded body was hardened, and the molded body was released from the molding die and taken out therefrom. As a result, the bottom-face member and the casing part were firmly joined together. Moreover, the fine structure of the functional surface was maintained well, and there was no particular problem in appearance.

### Eighth Example

Insert molding was performed on a bottom-face member formed of PMMA (poly-methylmethacrylate) (Acrypet (registered trademark) (grade MD) made by MITSUBISHI RAYON Co., Ltd., contact angle: 73.2 degrees, and glass transition temperature (Tg): 105° C.) using polystyrene (PS) (Mw=192,000 pellet made by ALDRICH Co., Ltd., contact angle: 82.7 degrees, and glass transition temperature (Tg): 100° C.) that was the material of a casing part. The temperature and the injection pressure of a melted resin were adjusted to 240° C., 135 MPa, respectively, and the temperature of the die was adjusted to 85° C. at the fixed side, and to 85° C. at the movable side. After the resin was injected, the die was cooled at a temperature equal to or lower than a temperature at which a molded body was hardened, and the molded body was released from the molding die and taken out therefrom. As a result, the bottom-face member and the casing part were firmly joined together. Moreover, the fine structure of the functional surface was maintained well, and there was no particular problem in appearance.

### First Comparative Example

Insert molding was performed on a bottom-face member formed of cyclo-olefin polymer (ZF-14 made by ZEON Corporation, contact angle: 94.2 degrees, and glass transition temperature (Tg): 136° C.) using polystyrene (PS) (Mw=192,000 pellet made by ALDRICH Co., Ltd., contact angle: 82.7 degrees, and glass transition temperature (Tg): 100° C.) that was the material of a casing part. The temperature and the injection pressure of a melted resin were adjusted to 240° C., 135 MPa, respectively, and the temperature of the die was adjusted to 85° C. at the fixed side, and to 85° C. at the movable side. After the resin was injected, the die was cooled at a temperature equal to or lower than a temperature at which a molded body was hardened, and the molded body was released from the molding die and taken out therefrom. As a result, the fine structure of the functional surface was maintained well, and there was no particular problem in appearance, but the bottom-face member and the casing part were not joined together.

### Second Comparative Example

Insert molding was performed on a bottom-face member formed of cyclo-olefin polymer (ZF-14 made by ZEON Corporation, contact angle: 94.2 degrees, and glass transition temperature (Tg): 136° C.) using PMMA (poly-methylmethacrylate) (Acrypet (registered trademark) (grade MD) made by MITSUBISHI RAYON Co., Ltd., contact angle: 73.2 degrees, and glass transition temperature (Tg): 105° C.) that was the material of a casing part. The temperature and the injection pressure of a melted resin were adjusted to 260° C., 175 MPa, respectively, and the temperature of the die was adjusted to 120° C. at the fixed side, and to 85° C. at the movable side. After the resin was injected, the die was cooled at a temperature equal to or lower than a temperature at which a molded body was hardened, and the molded body was released from the molding die and taken out therefrom. As a result, the fine structure of the functional surface was maintained well, and there was no particular problem in appearance, but the bottom-face member and the casing part were not joined together.

### Third Comparative Example

Insert molding was performed on a bottom-face member formed of cyclo-olefin polymer (ZF-14 made by ZEON Corporation, contact angle: 94.2 degrees, and glass transition temperature (Tg): 136° C.) using PMMA (poly-methylmethacrylate) (product name: Sumipex MG5 made by SUMITOMO Chemical Co., Ltd., contact angle: 76.3 degrees, and glass transition temperature (Tg): 99° C.) that was the material of a casing part. The temperature and the injection pressure of a melted resin were adjusted to 250° C., 135 MPa, respectively, and the temperature of the die was adjusted to 120° C. at the fixed side, and to 80° C. at the movable side. After the resin was injected, the die was cooled at a temperature equal to or lower than a temperature at which a molded body was hardened, and the molded body was released from the molding die and taken out therefrom. As a result, the fine structure of the functional surface was maintained well, and there was no particular problem in appearance, but the bottom-face member and the casing part were not joined together.

### Fourth Comparative Example

Insert molding was performed on a bottom-face member formed of cyclo-olefin polymer (ZF-14 made by ZEON Corporation, contact angle: 94.2 degrees, and glass transition temperature (Tg): 136° C.) using an acrylonitrile/butadiene/styrene resin (ABS) (product name: TOYOLAC100 made by TORAY Industries, Inc., contact angle: 86.1 degrees, and glass transition temperature (Tg): 83° C.) that was the material of a casing part. The temperature and the injection pressure of a melted resin were adjusted to 250° C., 1405 MPa, respectively, and the temperature of the die was adjusted to 120° C. at the fixed side, and to 80° C. at the movable side. After the resin was injected, the die was cooled at a temperature equal to or lower than a temperature at which a molded body was hardened, and the molded body was released from the molding die and taken out therefrom. As a result, the fine structure of the functional surface was maintained well, and there was no particular problem in appearance, but the bottom-face member and the casing part were not joined together.

### Fifth Comparative Example

Insert molding was performed on a bottom-face member formed of cyclo-olefin polymer (ZF-14 made by ZEON Corporation, contact angle: 94.2 degrees, and glass transition temperature (Tg): 136° C.) using cyclo-olefin copolymer (COC) (TOPAS8007 made by Polyplastics Co., Ltd., contact angle: 86.0 degrees, and glass transition temperature (Tg): 78° C.) that was the material of a casing part. The temperature and the injection pressure of a melted resin were adjusted to 210° C., 135 MPa, respectively, and the temperature of the die was adjusted to 85° C. at the fixed side, and to 85° C. at the movable side. After the resin was injected, the die was cooled at a temperature equal to or lower than a temperature at which a molded body was hardened, and the molded body was released from the molding die and taken out therefrom. As a result, although the bottom-face member and the casing part were firmly joined together, there were problems in appearance such that the product was distorted and the film was melted.

### Sixth Comparative Example

Insert molding was performed on a bottom-face member formed of cyclo-olefin copolymer (COC) (TOPAS8007 made by Polyplastics Co., Ltd., contact angle: 86.0 degrees, and glass transition temperature (Tg): 78° C.) using cyclo-olefin polymer (ZF-14 made by ZEON Corporation, contact angle: 94.2 degrees, and glass transition temperature (Tg): 136° C.) that was the material of a casing part. The temperature and the injection pressure of a melted resin were adjusted to 260° C., 165 MPa, respectively, and the temperature of the die was adjusted to 120° C. at the fixed side, and to 85° C. at the movable side. After the resin was injected, the die was cooled at a temperature equal to or lower than a temperature at which a molded body was hardened, and the molded body was released from the molding die and taken out therefrom. As a result, although the bottom-face member and the casing part were firmly joined together, there were problems in appearance such that the product was distorted and the film was melted.

### Seventh Comparative Example

Insert molding was performed on a bottom-face member formed of cyclo-olefin copolymer (COC) (TOPAS8007 made by Polyplastics Co., Ltd., contact angle: 86.0 degrees, and glass transition temperature (Tg): 78° C.) using cyclo-olefin copolymer (COC) (480R made by ZEON Corporation, contact angle: 84.9 degrees, and glass transition temperature (Tg): 138° C.) that was the material of a casing part. The temperature and the injection pressure of a melted resin were adjusted to 290° C., 140 MPa, respectively, and the temperature of the die was adjusted to 80° C. at the fixed side, and to 80° C. at the movable side. After the resin was injected, the die was cooled at a temperature equal to or lower than a temperature at which a molded body was hardened, and the molded body was released from the molding die and taken out therefrom. As a result, although the bottom-face member and the casing part were firmly joined together, there was a problem in appearance such that the film was largely deflected because of heat.

The above-explained results were summarized in table 1 below, where C.E. stands for a Comparative Example.

TABLE 1

| | Bottom-face Member | | | Casing Part | | | Δ | | | |
|---|---|---|---|---|---|---|---|---|---|---|
| | | Contact | | | Contact | | Difference | Difference | Result | |
| | | Angle | Tg | | Angle | Tg | in Contact | in Tg (Δ | Joining | |
| | Resin | (Degree) | (° C.) | Resin | (Degree) | (° C.) | Angle (Δ°) | Degree) | Property | Appearance |
| First | ZF-14 | 94.2 | 136 | TOPAS | 84.1 | 134 | 10.1 | 2 | ∘ | ∘ |
| example | | | | 5013 | | | | | | |
| Second | ZF-14 | 94.2 | 136 | TOPAS | 83.5 | 138 | 10.7 | 2 | ∘ | ∘ |
| example | | | | 6013 | | | | | | |
| Third | ZF-14 | 94.2 | 136 | 1060R | 84.9 | 100 | 9.3 | 36 | ∘ | ∘ |
| Example | | | | | | | | | | |
| Fourth | ZF-14 | 94.2 | 136 | 480R | 84.9 | 138 | 9.3 | 2 | ∘ | ∘ |
| Example | | | | | | | | | | |
| Fifth | TOPAS | 84.1 | 134 | Acrypet | 73.2 | 105 | 10.9 | 29 | ∘ | ∘ |
| Example | 5013 | | | | | | | | | |
| Sixth | TOPAS | 83.5 | 138 | Acrypet | 73.2 | 105 | 10.3 | 33 | ∘ | ∘ |
| Example | 6013 | | | | | | | | | |
| Seventh | TOPAS | 86.0 | 78 | PS | 82.7 | 100 | 3.3 | 22 | ∘ | ∘ |
| Example | 8007 | | | | | | | | | |
| Eighth | Acrypet | 73.2 | 105 | PS | 82.7 | 100 | 9.5 | 5 | ∘ | ∘ |
| Example | | | | | | | | | | |
| First C.E | ZF-14 | 94.2 | 136 | PS | 82.7 | 100 | 11.5 | 36 | x | ∘ |
| Second | ZF-14 | 94.2 | 136 | Acrypet | 73.2 | 105 | 21.0 | 31 | x | ∘ |
| C.E | | | | | | | | | | |
| Third | ZF-14 | 94.2 | 136 | Sumipex | 76.3 | 99 | 17.9 | 37 | x | ∘ |
| C.E | | | | | | | | | | |
| Fourth | ZF-14 | 94.2 | 136 | Toyolac | 86.1 | 83 | 8.1 | 53 | x | ∘ |
| C.E. | | | | | | | | | | |
| Fifth | ZF-14 | 94.2 | 136 | TOPAS | 86.0 | 78 | 8.2 | 58 | ∘ | x |
| C.E. | | | | 8007 | | | | | | |
| Sixth | TOPAS | 86.0 | 78 | ZF-14 | 94.2 | 136 | 8.2 | 58 | ∘ | x |
| C.E. | 8007 | | | | | | | | | |
| Seventh | TOPAS | 86.0 | 78 | 480R | 84.9 | 138 | 1.1 | 60 | ∘ | x |
| C.E. | 8007 | | | | | | | | | |

As is clear from the table, it is preferable that the difference in the water contact angle between the material of the bottom-face member and that of the casing part should be equal to or smaller than 11 degrees, and the difference in the glass transition temperature between the material of the bottom-face member and that of the casing part should be equal to or lower than 50° C.

Next, an explanation will be given of ninth to eleventh examples and eighth to tenth comparative examples in which a material that was difficult to join was mixed with a material having a difference in the water contact angle between the material of the bottom-face member and that of the casing part being equal to or smaller than 11 degrees and a difference in the glass transition temperature therebetween being equal to or lower than 50° C.

### Ninth Example

Insert molding was performed on a bottom-face member formed of cyclo-olefin polymer (ZF-14 made by ZEON Corporation, contact angle: 94.2 degrees, and glass transition temperature (Tg): 136° C.) using a resin obtained by mixing a syndiotactic polystyrene resin (SPS) (XAREC S-131 (GF30%) made by IDEMITSU KOSAN Co., Ltd., contact angle: 93.8 degrees, and melting point: 270° C.) with cyclo-olefin polymer (COP) (1420R made by ZEON Corporation, contact angle: 94.2 degrees, and glass transition temperature (Tg): 136° C.) at a ratio of 6:4 which was the material of the casing part. The temperature and the injection pressure of a melted resin were adjusted to 290° C., 165 MPa, respectively, and the temperature of the die was adjusted to 120° C. at the fixed side, and to 85° C. at the movable side. After the resin was injected, the die was cooled at a temperature equal to or lower than a temperature at which a molded body was hardened, and the molded body was released from the molding die and taken out therefrom. As a result, the bottom-face member and the casing part were firmly joined together. Moreover, the fine structure of the functional surface was maintained well, and there was no particular problem in appearance.

### Eighth Comparative Example

Insert molding was performed on a bottom-face member formed of cyclo-olefin polymer (ZF-14 made by ZEON Corporation, contact angle: 94.2 degrees, and glass transition temperature (Tg): 136° C.) using a resin obtained by mixing a syndiotactic polystyrene resin (SPS) (XAREC S-131 (GF30%) made by IDEMITSU KOSAN Co., Ltd., contact angle: 93.8 degrees, and melting point: 270° C.) with cyclo-olefin polymer (COP) (1420R made by ZEON Corporation, contact angle: 94.2 degrees, and glass transition temperature (Tg): 136° C.) at a ratio of 8:2 which was the material of the casing part. The temperature and the injection pressure of a melted resin were adjusted to 290° C., 165 MPa, respectively, and the temperature of the die was adjusted to 120° C. at the fixed side, and to 85° C. at the movable side. After the resin was injected, the die was cooled at a temperature equal to or lower than a temperature at which a molded body was hardened, and the molded body was released from the molding die and taken out therefrom. As a result, the fine structure of the functional surface was maintained well, and there was no problem in appearance, but the bottom-face member and the casing part were not joined together.

The above-explained results were summarized in table 2 below, where C.E. stands for a comparative example.

TABLE 2

| | Bottom-face Member | | | Casing Part | | | | | |
|---|---|---|---|---|---|---|---|---|---|
| | | Contact | | | Contact | Tg or | | Result | |
| | | Angle | Tg | | Angle | Melting | | Joining | |
| | Resin | (Degree) | (° C.) | Resin | (Degree) | Point (° C.) | Ratio | Property | Appearance |
| Ninth | ZF-14 | 94.2 | 136 | XAREC | 93.8 | 270 | 60 | ∘ | ∘ |
| Example | | | | 1420R | 94.2 | 136 | 40 | | |
| Eighth | ZF-14 | 94.2 | 136 | XAREC | 93.8 | 270 | 80 | x | ∘ |
| C.E. | | | | 1420R | 94.2 | 136 | 20 | | |

### Tenth Example

Insert molding was performed on a bottom-face member formed of cyclo-olefin polymer (ZF-14 made by ZEON Corporation, contact angle: 94.2 degrees, and glass transition temperature (Tg): 136° C.) using a resin obtained by mixing PMMA (poly-methylmethacrylate) (product name: Sumipex MG5 made by SUMITOMO Chemical Co., Ltd., contact angle: 76.3 degrees, and glass transition temperature (Tg): 99° C.) with cyclo-olefin polymer(COP) (1420R made by ZEON Corporation, contact angle: 94.2 degrees, and glass transition temperature (Tg): 136° C.) at a ratio of 6:4 which was the material of the casing part. The temperature and the injection pressure of a melted resin were adjusted to 260° C., 135 MPa, respectively, and the temperature of the die was adjusted to 120° C. at the fixed side, and to 80° C. at the movable side. After the resin was injected, the die was cooled at a temperature equal to or lower than a temperature at which a molded body was hardened, and the molded body was released from the molding die and taken out therefrom. As a result, the bottom-face member and the casing part were firmly joined together. Moreover, the fine structure of the functional surface was maintained well, and there was no particular problem in appearance.

### Ninth Comparative Example

Insert molding was performed on a bottom-face member formed of cyclo-olefin polymer (ZF-14 made by ZEON Corporation, contact angle: 94.2 degrees, and glass transition temperature (Tg): 136° C.) using a resin obtained by mixing PMMA (poly-methylmethacrylate) (product name: Sumipex MG5 made by SUMITOMO Chemical Co., Ltd., contact angle: 76.3 degrees, and glass transition temperature (Tg): 99° C.) with cyclo-olefin polymer (COP) (1420R made by ZEON Corporation, contact angle: 94.2 degrees, and glass transition temperature (Tg): 136° C.) at a ratio of 8:2 which was the material of the casing part. The temperature and the injection pressure of a melted resin were adjusted to 260° C., 135 MPa, respectively, and the temperature of the die was adjusted to 120° C. at the fixed side, and to 80° C. at the movable side. After the resin was injected, the die was cooled at a temperature equal to or lower than a temperature at which a molded body was hardened, and the molded body was released from the molding die and taken out therefrom. As a result, the fine structure of the functional surface was maintained well, and there was no problem in appearance, but joining of the bottom-face member with the casing part was insufficient, and both pieces were easily separated.

The above-explained results were summarized in table 3 below, where C.E. stands for a comparative example.

TABLE 3

| | Bottom-face Member | | | Casing Part | | | | | |
|---|---|---|---|---|---|---|---|---|---|
| | | Contact | | | Contact | | | Result | |
| | | Angle | Tg | | Angle | Tg | | Joining | |
| | Resin | (Degree) | (° C.) | Resin | (Degree) | (° C.) | Ratio | Property | Appearance |
| Tenth | ZF-14 | 94.2 | 136 | Sumipex | 76.3 | 99 | 60 | ∘ | ∘ |
| Example | | | | 1420R | 94.2 | 136 | 40 | | |
| Ninth | ZF-14 | 94.2 | 136 | Sumipex | 76.3 | 99 | 80 | Δ | ∘ |
| C.E. | | | | 1420R | 94.2 | 136 | 20 | | |

### Eleventh Example

Insert molding was performed on a bottom-face member formed of cyclo-olefin polymer (ZF-14 made by ZEON Corporation, contact angle: 94.2 degrees, and glass transition temperature (Tg): 136° C.) using a resin obtained by mixing an acrylonitrile/butadiene/styrene resin (ABS) (product name: TOYOLAC100 made by TORAY Industries, Inc., contact angle: 86.1 degrees, and glass transition temperature (Tg): 83° C.) with cyclo-olefin polymer (COP) (1420R made by ZEON Corporation, contact angle: 94.2 degrees, and glass transition temperature (Tg): 136° C.) at a ratio of 6:4 which was the material of the casing part. The temperature and the injection pressure of a melted resin were adjusted to 250° C., 140 MPa, respectively, and the temperature of the die was adjusted to 120° C. at the fixed side, and to 80° C. at the movable side. After the resin was injected, the die was cooled at a temperature equal to or lower than a temperature at which a molded body was hardened, and the molded body was released from the molding die and taken out therefrom. As a result, the bottom-face member and the casing part were firmly joined together. Moreover, the fine structure of the functional surface was maintained well, and there was no particular problem in appearance.

### Tenth Comparative Example

Insert molding was performed on a bottom-face member formed of cyclo-olefin polymer (ZF-14 made by ZEON Corporation, contact angle: 94.2 degrees, and glass transition temperature (Tg): 136° C.) using a resin obtained by mixing an acrylonitrile/butadiene/styrene resin (ABS) (product name: TOYOLAC100 made by TORAY Industries, Inc., contact angle: 86.1 degrees, and glass transition temperature (Tg): 83° C.) with cyclo-olefin polymer (COP) (1420R made by ZEON Corporation, contact angle: 94.2 degrees, and glass transition temperature (Tg): 136° C.) at a ratio of 8:2 which was the material of the casing part. The temperature and the injection pressure of a melted resin were adjusted to 250° C., 140 MPa, respectively, and the temperature of the die was adjusted to 120° C. at the fixed side, and to 80° C. at the movable side. After the resin was injected, the die was cooled at a temperature equal to or lower than a temperature at which a molded body was hardened, and the molded body was released from the molding die and taken out therefrom. As a result, the fine structure of the functional surface was maintained well, and there was no problem in appearance, but joining of the bottom-face member with the casing part was insufficient, and both pieces were easily separated.

The above-explained results were summarized in table 4 below, where C.E. stands for a comparative example.

TABLE 4

| | Bottom-face Member | | | Casing Part | | | | | |
|---|---|---|---|---|---|---|---|---|---|
| | | Contact | | | Contact | | | Result | |
| | | Angle | | | Angle | | | Joining | |
| | Resin | (Degree) | Tg (° C.) | Resin | (Degree) | Tg (° C.) | Ratio | Property | Appearance |
| Eleventh | ZF-14 | 94.2 | 136 | Toyolac | 86.1 | 83 | 60 | ∘ | ∘ |
| Example | | | | 1420R | 94.2 | 136 | 40 | | |
| Tenth | ZF-14 | 94.2 | 136 | Toyolac | 86.1 | 83 | 80 | Δ | ∘ |
| C.E. | | | | 1420R | 94.2 | 136 | 20 | | |

As is clear from the above-explained results, when materials which have a difference in the contact angle that exceeds 11 degrees and which are difficult to be joined together and materials which have a difference in the glass transition temperature or the melting point that exceeds 50° C. and which are difficult to be joined together are used, if a material having a difference in the water contact angle from the material of the bottom-face member equal to or smaller than 11 degrees and having a difference in the glass transition temperature equal to or lower than 50° C. is mixed in the material of the casing part at equal to or larger than 40 wt %, joining of the bottom-face member with the casing part is enabled.

1. A functional-container forming method for forming a casing part on a bottom-face member having a predetermined functional surface, the functional-container forming method comprising the steps of:
forming a protection region that suppresses a deterioration of a function of the functional surface between the functional surface and a molding die; and
performing a molding by filling a melted resin in a cavity formed between the molding die and the bottom-face member.

2. The functional-container forming method according to claim 1, wherein a difference in a water contact angle between a material of the bottom-face member and a material of the casing part is equal to or smaller than 11 degrees.

3. The functional-container forming method according to claim 1, wherein a difference in a glass transition temperature or a melting point between a material of the bottom-face member and a material of the casing part is equal to or lower than 50° C.

4. The functional-container forming method according to claim 1, wherein a difference in a water contact angle between a material of the bottom-face member and a material of the casing part is equal to or smaller than 11 degrees and a difference in a glass transition temperature or a melting point between the material of the bottom-face member and the material of the casing part is equal to or lower than 50° C.

5. The functional-container forming method according to claim 1, wherein the material of the casing part contains equal to or larger than at least 40 wt % of material having a difference in the water contact angle from the material of the bottom-face member being equal to or smaller than 11 degrees and having a difference in the glass transition temperature or the melting point from the material of the bottom-face member being equal to or lower than 50° C.

6. The functional-container forming method according to claim 1, wherein the molding die is divided into a plurality of pieces, and each piece is released at a different timing.

7. The functional-container forming method according to claim 1, wherein a temperature of the melted resin is adjusted to be equal to or lower than a temperature at which the function of the functional surface is not deteriorated.

8. The functional-container forming method according to claim 1, wherein a temperature of the bottom-face member is adjusted to be equal to or lower than a temperature at which the function of the functional surface is not deteriorated.

9. A molding die for forming a casing part on a bottom-face member having a predetermined functional surface, the molding die comprising:
a molding part for molding the casing part on the bottom-face member; and
a functional-surface protecting part for forming a protection region that suppresses a deterioration of the functional surface at the time of molding between the functional surface and the molding die.

10. The molding die according to claim 9, wherein the molding part is divided into a plurality of pieces, and each piece is independently movable.

11. The molding die according to claim 9, wherein the functional-surface protecting part has a portion which faces the functional surface at the time of molding and which is formed as a hollow.

12. The molding die according to claim 11, wherein the functional-surface protecting part has a portion which is proximate to the bottom-face member and which is formed as a curved surface.

13. The molding die according to claim 9, wherein the functional-surface protecting part is formed of a material having a lower thermal conductivity than the thermal conductivity of the molding part.

14. A functional container comprising:
a bottom-face member having a predetermined functional surface; and
a casing part joined to the bottom-face member by insert molding.

15. (canceled)

16. The functional container according to claim 14, wherein the casing part is formed on the bottom-face member by using a molding die comprising:
a molding part for molding the casing part on the bottom-face member; and
a functional-surface protecting part for forming a protection region that suppresses a deterioration of the functional surface at the time of molding between the functional surface and the molding die.

17. The functional container according to claim 14, wherein a difference in a water contact angle between a material of the bottom-face member and a material of the casing part is equal to or smaller than 11 degrees.

18. The functional container according to claim 14, wherein a difference in a glass transition temperature or a melting point between a material of the bottom-face member and a material of the casing part is equal to or lower than 50° C.

19. The functional container according to claim 14, wherein a difference in a water contact angle between a material of the bottom-face member and a material of the casing part is equal to or smaller than 11 degrees and a difference in a glass transition temperature or a melting point between the material of the bottom-face member and the material of the casing part is equal to or lower than 50° C.

20. The functional container according to claim 14, wherein a material of the casing part contains equal to or larger than at least 40 wt % of material having a difference in the water contact angle from a material of the bottom-face member being equal to or smaller than 11 degrees and having a difference in the glass transition temperature or the melting point from the material of the bottom-face member being equal to or lower than 50° C.
